(19) United States
(12) Patent Application Publication
(10) Pub. No.: US 2018/0100611 A1
(43) Pub. Date: Apr. 12, 2018

(54) DUCT TECHNOLOGIES

(71) Applicant: Green HVAC Ducts USA, LLC, White Plains, NY (US)

(72) Inventor: Carl Fanelli, Mahopac, NY (US)

(21) Appl. No.: 15/573,617

(22) PCT Filed: Feb. 29, 2016
(86) PCT No.: PCT/US2016/020060

§ 371 Date: Nov. 13, 2017

Related U.S. Application Data
(60) Provisional application No. 62/164,468, filed on May 20, 2015.

(51) Int. Cl. F16L 25/14; F24F 13/02; F16L 25/00

(52) U.S. Cl. CPC F16L 25/14; F16L 25/0009; F24F 13/0209

(57) ABSTRACT

A device comprising an HVAC duct interconnector comprising a tube and a wall extending within the tube. The present disclosure at least partially addresses at least one of the above. However, the present disclosure can prove useful to other technical areas. Therefore, the claims should not be construed as necessarily limited to addressing any of the above. An example embodiment of the present disclosure provides a device comprising an HVAC duct interconnector comprising a tube and a wall extending within the tube.

### CROSS REFERENCE TO RELATED APPLICATIONS

The present application claims the benefit of U.S. Provisional Application Ser. No. 62/164,468 filed 20 May 2015; which is incorporated herein by reference in its entirety for all purposes.

### TECHNICAL FIELD

The present disclosure relates to ducts.

### BACKGROUND

In the present disclosure, where a document, an act and/or an item of knowledge is referred to and/or discussed, then such reference and/or discussion is not an admission that the document, the act and/or the item of knowledge and/or any combination thereof was at the priority date, publicly available, known to the public, part of common general knowledge and/or otherwise constitutes prior art under the applicable statutory provisions; and/or is known to be relevant to an attempt to solve any problem with which the present disclosure may be concerned with. Further, nothing is disclaimed.

A heating, ventilation, and air conditioning (HVAC) system is generally used to provide a comfortable air environment, whether indoors or in a vehicular cabin. For example, the HVAC system can provide temperature comfort or acceptable air quality in a building, whether residential or commercial. Accordingly, the HVAC system typically contains a ductwork, which can include a set of interconnected ducts configured to conduct forced air therethrough.

Installation, use, or maintenance of the HVAC system is generally regulated by a legal code, such as a local building code. Among other things, the legal code often mandates that the ductwork of the HVAC system be insulated, such as during installation, use, or maintenance of the HVAC system. One reason for such mandate is to encourage efficiency in energy use. Resultantly, when the HVAC system is in operation, the insulation reduces thermal energy transfer between the forced air within the ductwork of the HVAC system and ambient air outside the ductwork of the HVAC system. Such reduction of the thermal energy transfer promotes efficiency in energy use.

One method of insulating the ductwork of the HVAC system, such as to comply with the legal code, involves wrapping one or more insulation jackets around the ductwork and then sealing, such as via a tape, any remaining seams in the ductwork, outside of the one or more insulation jackets. Subsequently, the HVAC system is pressure tested to ensure absence of substantial leaks of the forced air from inside the ductwork to outside the ductwork. Although such method can sometimes be effective, various drawbacks remain. For example, the method can be time consuming, laborious, or costly to implement. Further, closing or interconnecting at least one of the ducts of the ductwork can be time consuming, laborious, or costly to implement, especially if the at least one of the ducts includes thermal insulation.

### BRIEF SUMMARY

The present disclosure at least partially addresses at least one of the above. However, the present disclosure can prove useful to other technical areas. Therefore, the claims should not be construed as necessarily limited to addressing any of the above.

An example embodiment of the present disclosure provides a device comprising an HVAC duct interconnector comprising a tube and a wall extending within the tube.

The present disclosure may be embodied in the form illustrated in the accompanying drawings. However, attention is called to the fact that the drawings are illustrative. Variations are contemplated as being part of the disclosure, limited only by the scope of the claims.

### BRIEF DESCRIPTION OF THE DRAWINGS

The accompanying drawings illustrate example embodiments of the present disclosure. Such drawings are not to be construed as necessarily limiting the disclosure. Like numbers and/or similar numbering scheme can refer to like and/or similar elements throughout.

FIG. 1 shows a perspective view of a duct interconnect device according to the present disclosure.

FIG. 2 shows a frontal view of a duct interconnect device according to the present disclosure.

FIG. 3 shows a cross-sectional lateral side view of a duct interconnect device according to the present disclosure.

FIG. 4 shows a close-up of a cross-sectional lateral side view of a duct interconnect device according to the present disclosure.

FIG. 5 shows a perspective view of a duct interconnect device before interconnecting a pair of ducts along a rectilinear conduction path according to the present disclosure.

FIG. 6 shows a perspective view of a duct interconnect device after interconnecting a pair of ducts along a rectilinear conduction path according to the present disclosure.

FIG. 7 shows a perspective view of a duct interconnect device being coupled to a duct and being closed off according to the present disclosure.

FIG. 8 shows a perspective view of a duct interconnect device according to the present disclosure.

FIG. 9 shows a perspective view of a duct interconnect device according to the present disclosure.

FIG. 10 shows a frontal view of a duct interconnect device according to the present disclosure.

FIG. 11 shows a cross-sectional lateral side view of a duct interconnect device according to the present disclosure.

FIG. 12 shows a lateral side view of a duct interconnect device according to the present disclosure.

FIG. 13 shows a perspective view of a duct interconnect device before interconnecting a pair of ducts along a non-rectilinear fluid conduction path according to the present disclosure.

FIG. 14 shows a perspective view of a duct interconnect device after interconnecting a pair of ducts along a non-rectilinear fluid conduction path according to the present disclosure.

FIG. 15 shows a perspective view of a duct interconnect device according to the present disclosure.

FIG. 16 shows a frontal view of a duct interconnect device according to the present disclosure.

FIG. 17 shows a lateral side view of a duct interconnect device according to the present disclosure.

FIG. 18 shows a cross-sectional lateral side view of a duct interconnect device according to the present disclosure.

FIG. 19 shows a close-up of a cross-sectional lateral side view of a duct interconnect device according to the present disclosure.

FIG. 20 shows a perspective view of a duct interconnect device before interconnecting a pair of ducts along a non-rectilinear conduction path according to the present disclosure.

FIG. 21 shows a perspective view of a duct interconnect device after interconnecting a pair of ducts along a non-rectilinear conduction path according to the present disclosure.

FIG. 22 shows a perspective view of a duct interconnect device with a wedge according to the present disclosure.

FIG. 23 shows a frontal view of a duct interconnect device with a wedge according to the present disclosure.

FIG. 24 shows a cross-sectional lateral side view of a duct interconnect device with a wedge according to the present disclosure.

FIG. 25 shows a perspective view of a duct interconnect device with a wedge according to the present disclosure.

FIG. 26 shows a lateral side view of a duct interconnect device with a wedge according to the present disclosure.

FIG. 27 shows a perspective view of a duct interconnect device with a wedge before interconnecting a pair of ducts along a rectilinear conduction path according to the present disclosure.

FIG. 28 shows a cross-sectional lateral side view of a duct interconnect device with a wedge according to the present disclosure.

FIG. 29 shows a perspective view of a duct interconnect device before interconnecting a pair of ducts along a rectilinear conduction path according to the present disclosure.

FIG. 30 shows a perspective view of a duct interconnect device being coupled to a duct and being closed off according to the present disclosure.

### DETAILED DESCRIPTION OF PREFERRED EMBODIMENTS

The present disclosure is now described more fully with reference to the accompanying drawings, in which example embodiments of the present disclosure are shown. The present disclosure may, however, be embodied in many different forms and should not be construed as necessarily being limited to the example embodiments disclosed herein. Rather, these example embodiments are provided so that the present disclosure is thorough and complete, and fully conveys the concepts of the present disclosure to those skilled in the relevant art.

Features described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity in any manner.

The terminology used herein can imply direct or indirect, full or partial, temporary or permanent, action or inaction, state of being or absence thereof, characteristic or absence thereof. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from the teachings of the present disclosure.

The terminology used herein is for describing particular example embodiments and is not intended to be necessarily limiting of the present disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence and/or addition of one or more other features, integers, steps, operations, elements, components, and/or groups thereof.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing, and/or other any other types of manufacturing. For example, some manufacturing processes include three dimensional (3D) printing, laser cutting, computer numerical control routing, milling, pressing, stamping, vacuum forming, hydroforming, injection molding, lithography, and so forth.

Any and/or all elements, as disclosed herein, can be and/or include, whether partially and/or fully, a solid, including a metal, a mineral, a gemstone, an amorphous material, a ceramic, a glass ceramic, an organic solid, such as wood and/or a polymer, such as rubber, a composite material, a semiconductor, a nanomaterial, a biomaterial and/or any combinations thereof. Any and/or all elements, as disclosed herein, can be and/or include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, opaqueness, luminescence, reflection, phosphorescence, anti-reflection and/or holography, a photo-sensitive coating, an electronic and/or thermal property coating, such as for passivity, insulation, resistance or conduction, a magnetic coating, a water-resistant and/or waterproof coating, a scent coating and/or any combinations thereof. Any and/or all elements, as disclosed herein, can be rigid, flexible, and/or any other combinations thereof. Any and/or all elements, as disclosed herein, can be identical and/or different from each other in material, shape, size, color and/or any measurable dimension, such as length, width, height, depth, area, orientation, perimeter, volume, breadth, density, temperature, resistance, and so forth.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” can be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings were turned over, then the elements described as being on the “lower” side of other elements would then be oriented on “upper” sides of the other elements. Similarly, if the device in one of the figures were turned over, elements described as “below” or “beneath” other elements would then be oriented “above” the other elements. Therefore, the example terms “below” and “lower” can encompass both an orientation of above and below.

As used herein, the term “about” and/or “substantially” refers to a +/−10% variation from the nominal value/term. Such variation is always included in any given value/term provided herein, whether or not such variation is specifically referred thereto.

U.S. Pat. No. 8,667,995 is herein fully incorporated by reference for all purposes. U.S. Provisional Patent Application 62/134,516 is herein fully incorporated by reference for all purposes. If any disclosures are incorporated herein by reference and such disclosures conflict in part and/or in whole with the present disclosure, then to the extent of conflict, and/or broader disclosure, and/or broader definition of terms, the present disclosure controls. If such disclosures conflict in part and/or in whole with one another, then to the extent of conflict, the later-dated disclosure controls.

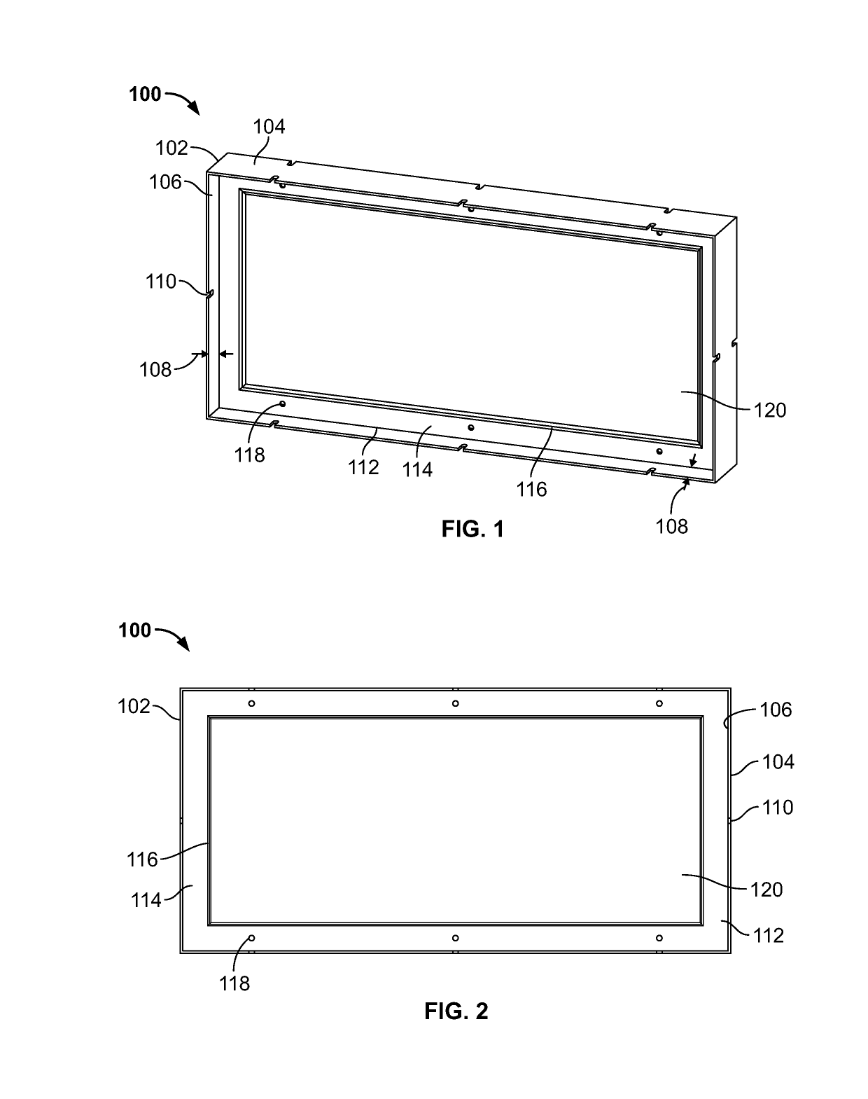

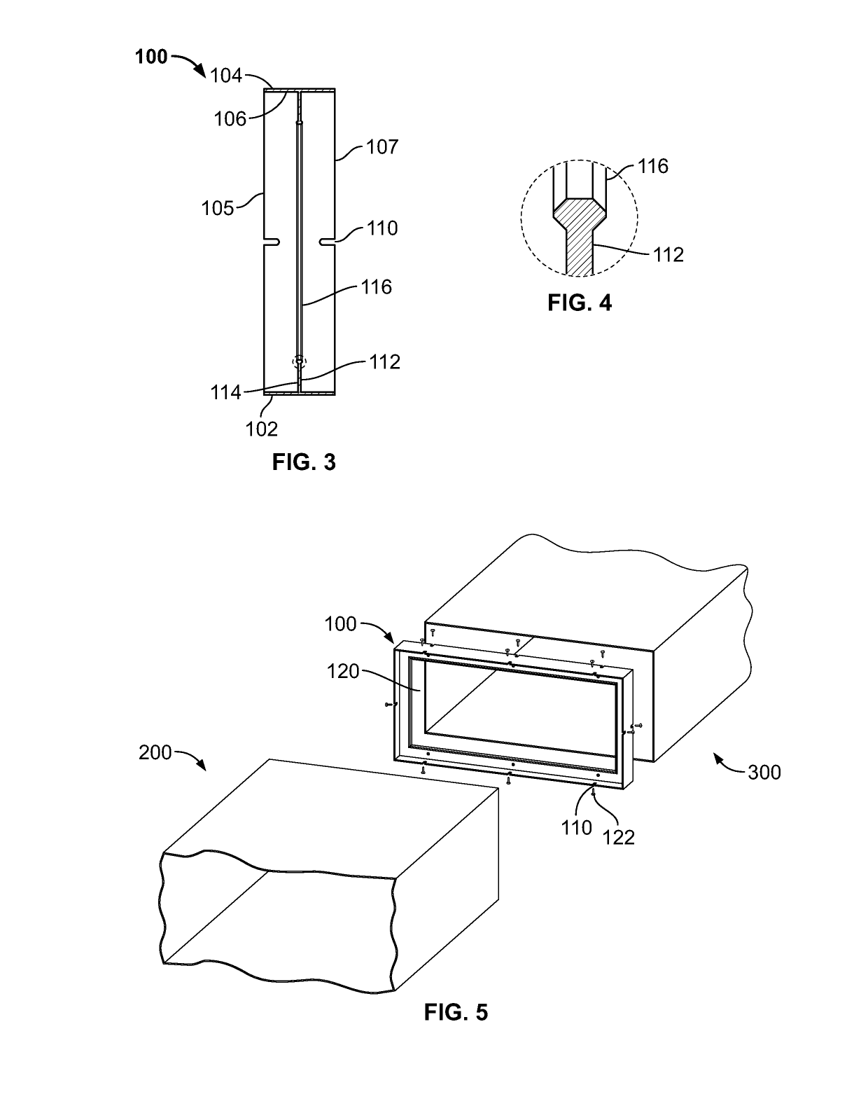

FIG. 1 shows a perspective view of a duct interconnect device according to the present disclosure. FIG. 2 shows a frontal view of a duct interconnect device according to the present disclosure. FIG. 3 shows a cross-sectional lateral side view of a duct interconnect device according to the present disclosure. FIG. 4 shows a close-up of a cross-sectional lateral side view of a duct interconnect device according to the present disclosure.

A duct interconnect device 100 is operative for use in an HVAC system in order to conduct or convey a forced fluid, such as a liquid or a gas. For example, the HVAC system can be indoors, such as in a building, whether residential or commercial, or in a vehicular cabin, such in a land, marine, or aerial vehicle. Also, for example, the fluid can include water or air. Further, for example, the forced fluid can be used in non-HVAC systems as well, such as for any type of fluid conduction or conveyance, whether pressure forced or gravity induced. In some embodiments, the duct interconnect device 100 is operative for use aboveground, underground, above water or under water, whether rested, suspended, raised, or buried, whether positioned on a waterbed or buried underneath the waterbed. In some embodiments, the duct interconnect device 100 is operative for use as an electrical conduit, such as for protection or routing of electrical wiring. In some embodiments, the duct interconnect device 100 is operative for use as a cable conduit, such as for protection or routing of a network cable. In some embodiments, the duct interconnect device 100 is operative for pipeline transport use, such as crude, petroleum, fuels, oil, natural gas, hydrogen, ammonia, biofuel, sewage, slurry, non-alcoholic or alcoholic beverage, irrigation, steam, district heating, or other substances, whether chemically stable or unstable, whether lightly or heavily pressurized. In some embodiments, the duct interconnect device 100 is an interconnector between at least two ducts. In some embodiments, the duct interconnect device 100 is an interconnector between a duct and at least one of a fluid input device, such as a fluid source, or a fluid output device, such as a fluid outlet.

The duct interconnect device 100 includes a tube 102 and a wall 112. The tube 102 and the wall 112 are a single piece, such as unitary. However, in other embodiments, the tube 102 and the wall 112 are an assembly of pieces.

The tube 102 includes an outer side 104 and an inner side 106. The tube 102 includes a set of end portions 105, 107. The tube 102 is substantially flat between the end portions 105, 107 on the outer side 104. The tube 102 is substantially flat between the end portions 105, 107 on the inner side 106. However, in some embodiments, the tube 102 is not substantially flat between the end portions 105, 107 on at least one of the outer side 104 or the inner side 106. The tube 102 defines a plurality of open slots 110 along a set of peripheral edges of the tube 102. The open slots 110 are U-shaped, but, can be shaped differently, such as a V-shape, a W-shape, a C-shape, or an E-shape, whether identical to or different from each other in shape.

The tube 102 is configured to conduct the forced fluid therethrough or for other uses, as described herein, such as along the inner side 106. The tube 102 has a rectangular cross-section, but in other embodiments, the tube 102 can be of any size, length, width, depth, shape, volume, thickness, or cross-section, such as triangular, circular, oval, square, trapezoid, pentagon, hexagon, octagon, or any other geometric shape. The tube 102 can be seamed or seamless, whether internally or externally, such as along the inner side 106 or the outer side 104. The tube 102 can include plastic, metal, wood, glass, stone, rubber, or any other material, whether biodegradable, flame-retardant, bacteria-resistant, or leak-proof, whether internally or externally, such as along the inner side 106 or the outer side 104. The tube 102 can extend longitudinally in a rectilinear, arcuate, sinusoidal, zigzag, pulse, or any other manner. The tube 102 can be of any color, such as white, black, blue, red, orange, purple, or others, whether internally or externally, such as along the inner side 106 or the outer side 104. The tube 102 can be reflective or anti-reflective, whether internally or externally, such as along the inner side 106 or the outer side 104. The tube 102 can define a bore, whether internally or externally, such as from the inner side 106 or the outer side 104, for use with a fastener, such as a screw. For example, the bore can be stopped, such as a well, or extend through the tube 102 fully, between the inner side 106 and the outer side 104. The tube 102 can be rigid or flexible. The tube 102 can be transparent, translucent, or opaque. The tube 102 can be solid or perforated. The tube 102 can define a lattice or a mesh. The outer side 104 or the inner side 106 can include an adhesive coating or a strip, such as a glue. The outer side 104 or the inner side 106 can include a hook-and-loop fastener strip.

In some embodiments, the tube 102 can include a computer or a sensor, such as a thermometer, a fluid pressure sensor, or another material property sensor, which can be configured for communication, whether in a wired or a wireless manner with another device, such as a mobile device, for instance, a tablet computer. In some embodiments, the outer side 104 comprises a photovoltaic cell configured to receive light energy and create electrical energy for storage within a power storage device, such as a battery. Note that the power storage device can be configured to provide power to the computer or the sensor. Also, note that the tube 102 can be positioned within a duct, a device, an apparatus, a machine, or a freestanding structure. In some embodiments, the tube 102 can include a network communication station, such as an antenna-based cell site or a network router, which can be powered via mains electricity, a power storage device, such as a battery, or the photovoltaic cell, whether local to the duct interconnect device 100 or remote to the duct interconnect device 100. For example, the network router can be a local area network (LAN) router.

The wall 112 extends from the tube 102 in a perpendicular manner. In other embodiments, the wall 112 extends from the tube 102 in a non-perpendicular manner, such as obtusely or acutely angled. The wall 112 is structured in a closed shape. For example, the closed shape can be an O-shape or a D-shape. Alternatively, the wall 112 is structured in an open shape, such as a U-shape, a C-shape, a V-shape, or an L-shape.

The wall 112 includes a set of lateral sides 114 and a top side 116 spanning between the lateral sides 114. Note that one of the lateral sides 114 is in proximity to the end portion 105 and another of the lateral sides 114 is in proximity to the end portion 107. The top side 116 defines an opening 120 therethrough. The forced fluid travels through the opening 120. The opening 120 is shaped as a rectangle, but can be shaped differently, such as triangular, circular, oval, square, trapezoid, pentagon, hexagon, octagon, or any other geometric shape. The top side 116 is chamfered, but in other embodiments, the top side 116 can be beveled or flat. In some embodiments, the tube 102 includes a column, which can be structurally identical to or different from the wall 112, whether in material, such as plastic, extension, such as rectilinear, or construction, such as unitary or assembly. The column can span between the inner sides 106 in any manner, such as horizontal, vertical, or diagonal, or be cantilevered from one of the inner sides 106 in any manner, such as horizontal, vertical, or diagonal. The column can also span between the top sides 116, such as horizontal, vertical, or diagonal or be cantilevered from one of the top sides 116, such as horizontal, vertical, or diagonal. The column can also span between the wall 112 and the tube 102, such as diagonally to buttress the wall 112 from the tube 102.

The wall 112 is non-segmented, such as via being continuous along an inner perimeter of the tube 102 extending along the inner side 106. In other embodiments, the wall 112 is segmented such that at least one open space is defined between a set of segments of the wall 112 such that a portion of the inner side 106 in the at least one open space is exposed to an overhead portion of the top side 116 facing that portion of the inner side 106. For example, the wall 112 can be segmented via being defined by a set of cantilevered pegs extending laterally from the inner side 106 of the tube 102.

The wall 112 define a set of bores 118 extending therethrough, between the opposing lateral sides 114. Each of the bores 118 is configured for use with a fastener, such as a screw. For example, a bolt can extend through at least one of the bores 118, where the bolt can host a nut outside of the wall 112, such as outside of the lateral sides 114.

The wall 112 is recessed with respect to the end portions 105, 107 and thereby extends within the tube 102 such that a set of open areas 108 is defined on the inner side 106 of the tube 102 between the lateral sides 114 and the peripheral edges of the tube 102, where the lateral sides 114 face the open areas 108. In other embodiments, the wall 112 is not recessed with respect to at least one of the end portions 105, 107 such that the open areas 108 are defined on one side of the tube 102 only, such as the end portion 105 or 107 side of the tube 102. Further, the wall 112 extends within the tube 102 such that the open areas 108 are relatively uniform in length along the lateral sides 114, with the length being measured from the lateral sides 114 to the end portions 105, 107. In other embodiments, the wall 112 extends within the tube 102 such that the open areas 108 are relatively varying in length along the lateral sides 114, with the length being measured from the lateral sides 114 to the end portions 105, 107. Note that at least one of the wall 112 or the inner side 106 of the tube 102 can be sufficiently sized such that the open areas 108 can be identical to or different from each other in length in any areas of the tube 102, with the length being measured from the lateral sides 114 to the end portions 105, 107. For example, at least one of the open areas 108 in proximity to the end portion 105 can have a first length from one of the lateral sides 114 to the end portion 105 and at least one of the open areas 108 in proximity to the end portion 107 can have a second length from another one of the lateral sides 114 to the end portion 107, where the first length and the second length can be identical to or different from each other. Likewise, the open areas 108 can be identical to or different from each other in other characteristics, such as texture.

The wall 112 extends laterally within the tube 102 such that the open spaces 108 are symmetrical to each other. In other embodiments, the wall 112 extends within the tube 102 such that the open spaces 108 are asymmetrical to each other. For example, the wall 112 can extend laterally within the tube 102 in a rectilinear manner, a diagonal manner, an arcuate manner, or a sinusoidal manner. In other embodiments, the wall 112 extends within the tube 102 in a helical manner between the end portions 105, 107, whether immediately therefrom or recessed therefrom.

The wall 112 is rectilinearly upright, but in other embodiments, the wall 112 can be arcuate, sinusoidal, zigzag, pulse-shaped, or extend vertically in any other manner. The wall 112 has a rectangular cross-section, but in other embodiments, the wall 112 can be of any size, length, width, depth, shape, volume, thickness, or cross-section, such as triangular, circular, oval, square, trapezoid, pentagon, hexagon, octagon, or any other geometric shape. The wall 112 can be seamed or seamless, such as along the lateral sides 114 or the top side 116. The wall 112 can include plastic, metal, wood, glass, stone, rubber, or any other material, whether biodegradable, flame-retardant, bacteria-resistant, or leak-proof, whether internally or externally, such as along the lateral sides 114 or the top side 116. Within the tube 102, the wall 112 can extend laterally in a rectilinear, arcuate, sinusoidal, zigzag, pulse, or any other manner. The wall 112 can be of any color, such as white, black, blue, red, orange, purple, or others, such as along the lateral sides 114 or the top side 116. The wall 112 can be reflective or anti-reflective, such as along the lateral sides 114 or the top side 116. The wall 112 can be rigid or flexible. The wall 112 can be transparent, translucent, or opaque. The wall 112 can be solid or perforated. The wall 112 can define a lattice or a mesh. The tube 102 and the wall 112 can be identical to or different from each other in a thermal insulation characteristic, as measured by an R-value suitable for technologies described herein. The lateral side 114 or the top side 116 can include an adhesive coating or a strip, such as a glue. The lateral side 114 or the top side 116 can include a hook-and-loop fastener strip.

In some embodiments, the wall 112 can include a computer or a sensor, such as a thermometer, a fluid pressure sensor, or another material property sensor, which can be configured for communication, whether in a wired or a wireless manner with another device, such as a mobile device, for instance, a tablet computer. In some embodiments, the wall 112 can include a network communication station, such as an antenna-based cell site or a network router, which can be powered via mains electricity or a power storage device, such as a battery. For example, the network router can be a local area network (LAN) router.

In some embodiments, the inner side 106, the lateral side 114, or the top side 116 can contact an insulation layer, such as a thermal insulation foam or a non-foam based material. The insulation layer can include polyurethane. The insulation layer can be phenolic. The insulation layer can include or be adhesive, one at least one side. The insulation layer can be biodegradable, flame-retardant, bacteria-resistant, or leak-proof. The insulation layer can include a plurality of particles, which can include plastic, metal, wood, glass, stone, rubber, or any other material, whether internally or externally, whether identical to or different from each other. The insulation layer can have the R-value measuring thermal insulation of at least about 7. However, the R-value of insulation layer can be lower as well. The insulation layer can be or include a spray foam filler. The insulation layer can have the R-value of about 7.5. The insulation layer can be coupled to the inner side 106, the lateral side 114, or the top side 116, such as via adhering, bonding, sonic sealing, or ultrasonic welding, or other coupling methodologies.

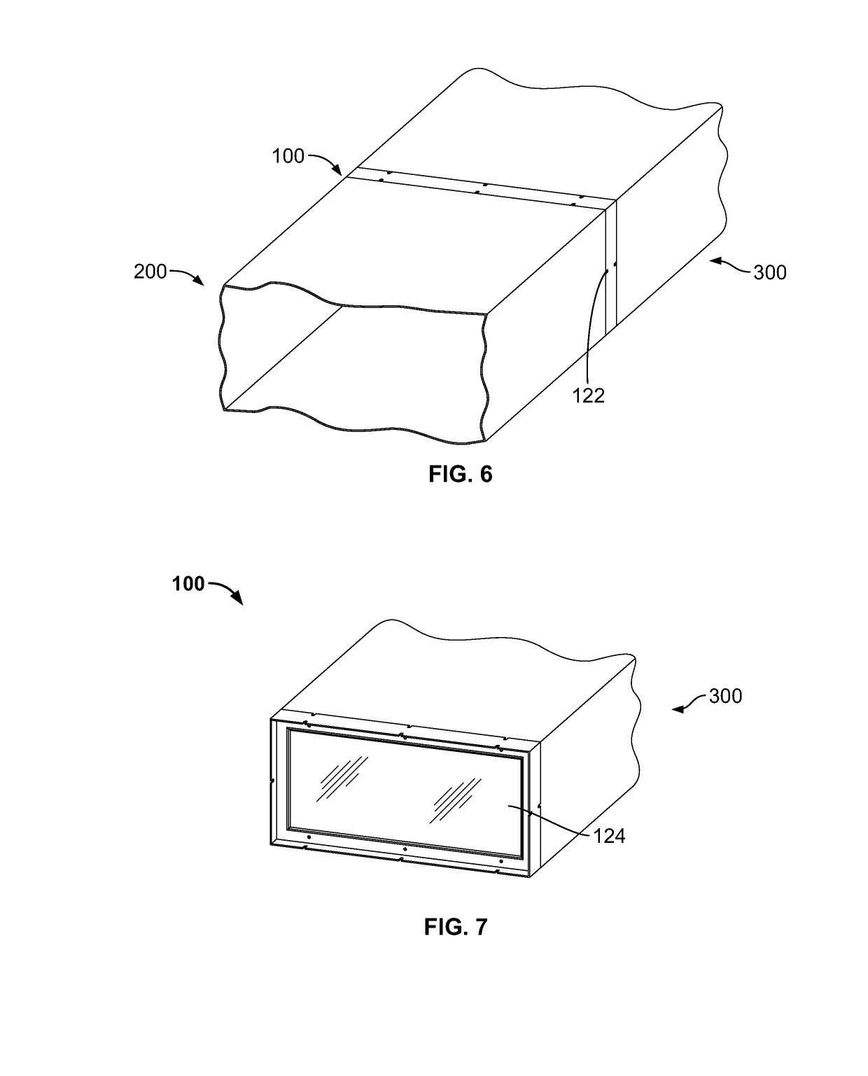

FIG. 5 shows a perspective view of a duct interconnect device before interconnecting a pair of ducts along a rectilinear conduction path according to the present disclosure. FIG. 6 shows a perspective view of a duct interconnect device after interconnecting a pair of ducts along a rectilinear conduction path according to the present disclosure. Some elements of these figures are described above. Thus, same reference characters identify identical and/or like components described above and any repetitive detailed description thereof will hereinafter be omitted or simplified in order to avoid complication.

The duct interconnect device 100 includes a plurality of fasteners 122, such as a bolt or a screw, which can be capable of coupling to a nut, such as helically. At least one of the fasteners 122 can include plastic, metal, wood, glass, stone, rubber, or any other material, whether biodegradable, flame-retardant, bacteria-resistant, or leak-proof. At least one of the fasteners 122 can be a one-piece construction or an assembly.

The duct interconnect device 100 is sized to receive at least one of an HVAC duct 200 or an HVAC duct 300 in a nesting manner such that at least one of the duct 200 or the duct 300 is positioned along the inner side 106 within the tube 102 of the duct interconnect device 100 and at least one of the duct 200 or the duct 300 is able to contact the lateral side 114 of the wall 112. Such contact can enable securing, as described herein. However, note that at least one of the duct 200 or the duct 300 can be positioned along the inner side 106 within the tube 102 of the duct interconnect device 100, yet not contact the lateral side 114 of the wall 112 such that an open space is defined. Note that such positioning can also enable securing, as described herein.

The duct 200 is coupled to the duct 300 via the duct interconnect device 100 such that the duct 200 and the duct 300 fluidly communicate with each other via the duct interconnect device 100 through the opening 120. At least one of the duct 200 or the duct 300 can be as described herein, such as disclosed in U.S. Pat. No. 8,667,995 or U.S. Provisional Patent Application 62/134,516, both of which are fully incorporated by reference herein for all purposes. Note that the duct 200 and the duct 300 can be identical to or different from each other in size, shape, structure, material, weight, internal volume, or any other duct property or characteristic.

The duct interconnect device 100 is secured to at least one of the duct 200 or the duct 300 via the fasteners 122 fastening through the open slots 110 into at least one of the duct 200 or the duct 300, whether solely, alternatively, or along with other ways of coupling, such as via fastening, adhering, mating, interlocking, clamping, hook-and-looping, magnetizing, or other coupling manners. Note that the duct interconnect device 100 can also secure to at least one of the duct 200 or the duct 300 via fasteners 122 through the bores 118. Further, note that the duct interconnect device 100 can be flush with at least one of the duct 200 or the duct 300 such that the outer side 104 of the duct interconnect device 100 is coplanar with an outer side of at least one of the duct 200 or the duct 300. In other embodiments, the duct interconnect device 100 can be non-flush, such as nested or telescoped, with at least one of the duct 200 or the duct 300 such that the outer side 104 of the duct interconnect device 100 is non-coplanar with the outer side of at least one of the duct 200 or the duct 300. Resultantly, the duct interconnect device 100 enables a conduction of a fluid along a rectilinear path between the duct 200 and the duct 300 through the opening 120 of the duct interconnect device 100.

FIG. 7 shows a perspective view of a duct interconnect device being coupled to a duct and being closed off according to the present disclosure. Some elements of these figures are described above. Thus, same reference characters identify identical and/or like components described above and any repetitive detailed description thereof will hereinafter be omitted or simplified in order to avoid complication.

The duct interconnect device 100 is coupled to the duct 300 on one of end portions 105, 107. The duct interconnect device 100 hosts a plate 124 closing up the opening 120, which can be hermetic sealing, such as airtight. The plate 124 can be coupled to the top side 116 or the lateral side 114 of the wall 112. The plate 124 can coupled to the inner side 106 of the tube 102. Such coupling can be via fastening, adhering, mating, interlocking, clamping, hook-and-looping, magnetizing, or other coupling manners. The plate 124 can be opaque, transparent, or translucent. The plate 124 can be reflective or anti-reflective. The plate 124 can include plastic, metal, wood, glass, stone, rubber, or any other material, whether biodegradable, flame-retardant, bacteria-resistant, or leak-proof.

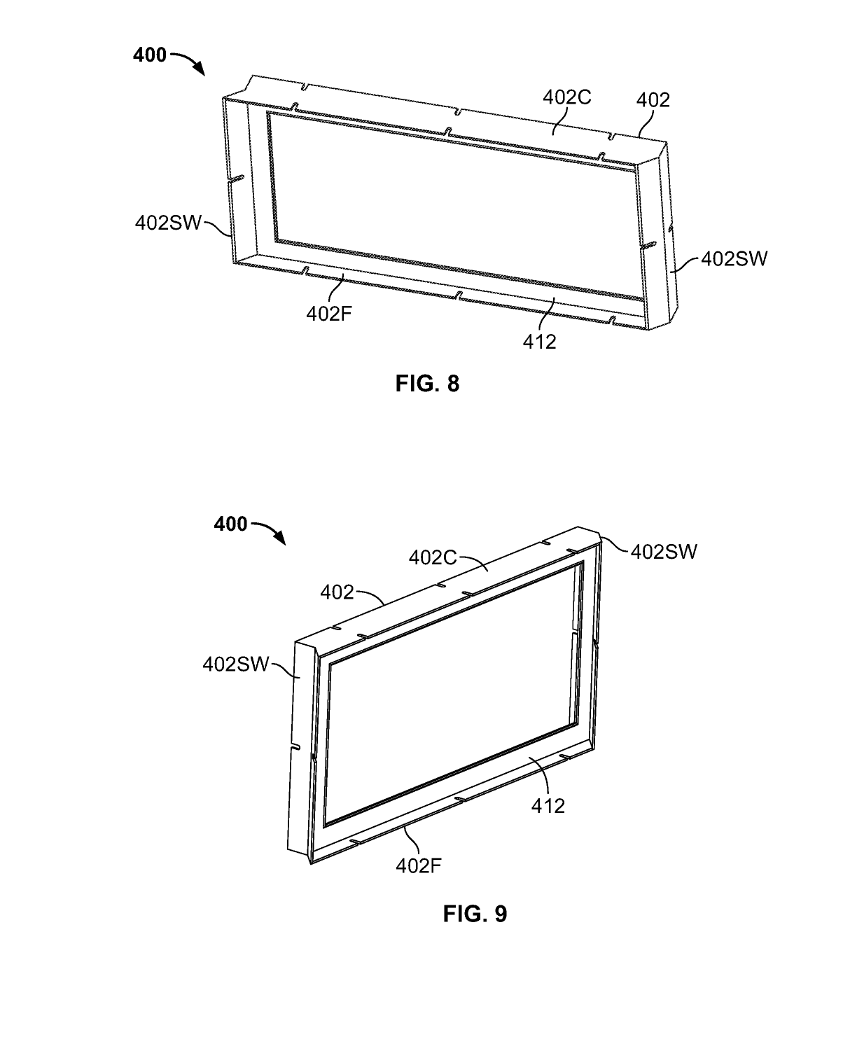

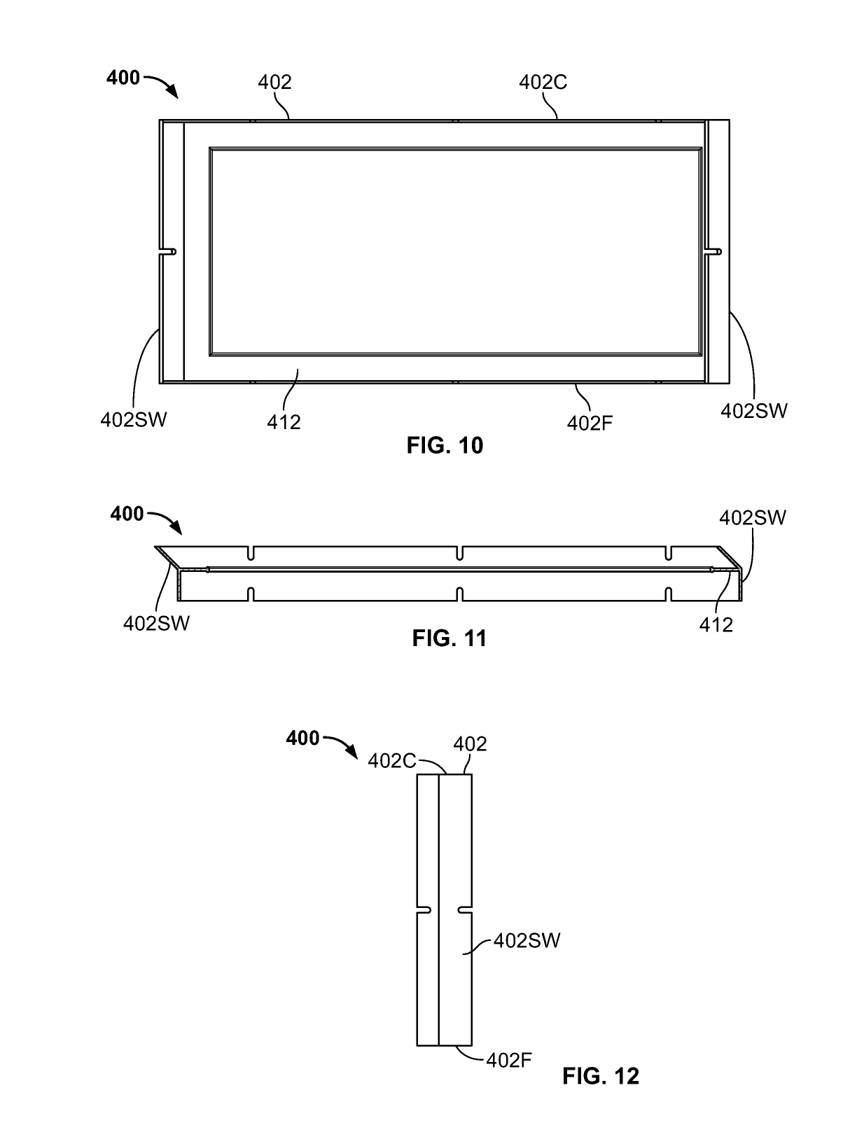

FIG. 8 shows a perspective view of a duct interconnect device according to the present disclosure. FIG. 9 shows a perspective view of a duct interconnect device according to the present disclosure. FIG. 10 shows a frontal view of a duct interconnect device according to the present disclosure. FIG. 11 shows a cross-sectional lateral side view of a duct interconnect device according to the present disclosure. FIG. 12 shows a lateral side view of a duct interconnect device according to the present disclosure. Some elements of these figures are described above. Thus, same reference characters identify identical and/or like components described above and any repetitive detailed description thereof will hereinafter be omitted or simplified in order to avoid complication.

A duct interconnect device 400 can be at least partially structurally similar to the duct interconnect device 100. The duct interconnect device 400 includes a tube 402 and a wall 412, as described above. The tube 402 includes a ceiling 402C, a floor 402F, and a pair of sidewalls 402SW spanning between the ceiling 402C and the floor 402F.

A difference between the duct interconnect device 100 and the duct interconnect device 400 is that the sidewalls 402SW are chamfered laterally, one internally and one externally, whether identical to or different from each other in angling, size, shape, material, or structure, as described herein. The ceiling 402C and the floor 402F are structured accordingly. Resultantly, the duct interconnect device 400 is able to interconnect a pair of ducts along a non-rectilinear fluid conduction path.

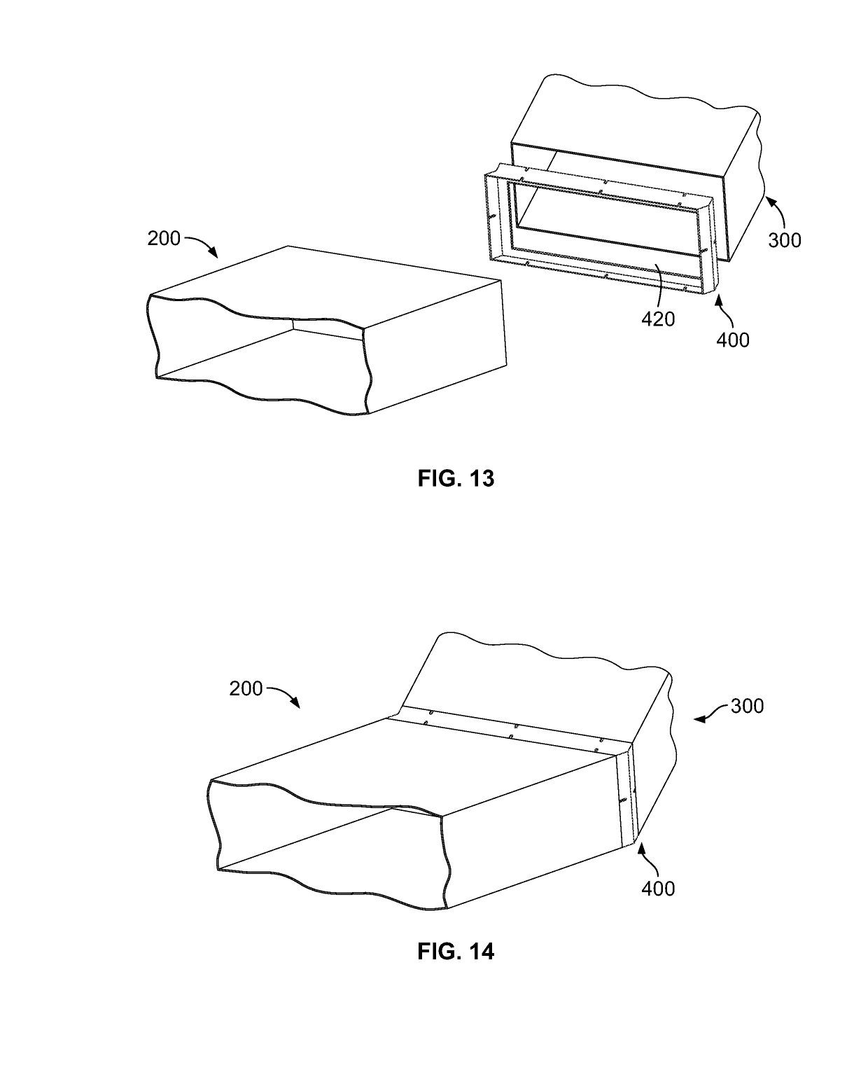

FIG. 13 shows a perspective view of a duct interconnect device before interconnecting a pair of ducts along a non-rectilinear conduction path according to the present disclosure. FIG. 14 shows a perspective view of a duct interconnect device after interconnecting a pair of ducts along a non-rectilinear conduction path according to the present disclosure. Some elements of these figures are described above. Thus, same reference characters identify identical and/or like components described above and any repetitive detailed description thereof will hereinafter be omitted or simplified in order to avoid complication.

The duct interconnect device 400 is sized to receive at least one of the duct 200 or the duct 300 in a nesting manner such that at least one of the duct 200 or the duct 300 is positioned along an inner side within the tube 402 of the duct interconnect device 400 and at least one of the duct 200 or the duct 300 is able to contact a lateral side of the wall 412. Such contact can enable securing, as described herein. However, note that at least one of the duct 200 or the duct 300 can be positioned along the inner side within the tube 402 of the duct interconnect device 400, yet not contact the lateral side of the wall 412 such that an open space is defined. Note that such positioning can also enable securing, as described herein.

The duct 200 is coupled to the duct 300 via the duct interconnect device 400 such that the duct 200 and the duct 300 fluidly communicate with each other via the duct interconnect device 400 through the opening 420. At least one of the duct 200 or the duct 300 can be as described herein, such as disclosed in U.S. Pat. No. 8,667,995 or U.S. Provisional Patent Application 62/134,516, both of which are fully incorporated by reference herein for all purposes. Note that the duct 200 and the duct 300 can be identical to or different from each other in size, shape, structure, material, weight, internal volume, or any other duct property or characteristic.

The duct interconnect device 400 can be secured to at least one of the duct 200 or the duct 300 via the fasteners 122 fastening through a set of U-shaped open slots into at least one of the duct 200 or the duct 300, whether solely, alternatively, or along with other ways of coupling, such as via fastening, adhering, mating, interlocking, clamping, hook-and-looping, magnetizing, or other coupling manners. Note that the duct interconnect device 400 can also secure to at least one of the duct 200 or the duct 300 via the fasteners 122 through a set of bores extending through the wall 412. Further, note that the duct interconnect device 400 can be flush with at least one of the duct 200 or the duct 300 such that an outer side of the duct interconnect device 400 is coplanar with an outer side of at least one of the duct 200 or the duct 300. In other embodiments, the duct interconnect device 400 can be non-flush, such as nested or telescoped, with at least one of the duct 200 or the duct 300 such that the outer side of the duct interconnect device 400 is non-coplanar with the outer side of at least one of the duct 200 or the duct 300. Resultantly, the duct interconnect device 400 enables a conduction of a fluid along a non-rectilinear path, such as a laterally arcuate path, between the duct 200 and the duct 300 through the opening 420 of the duct interconnect device 400.

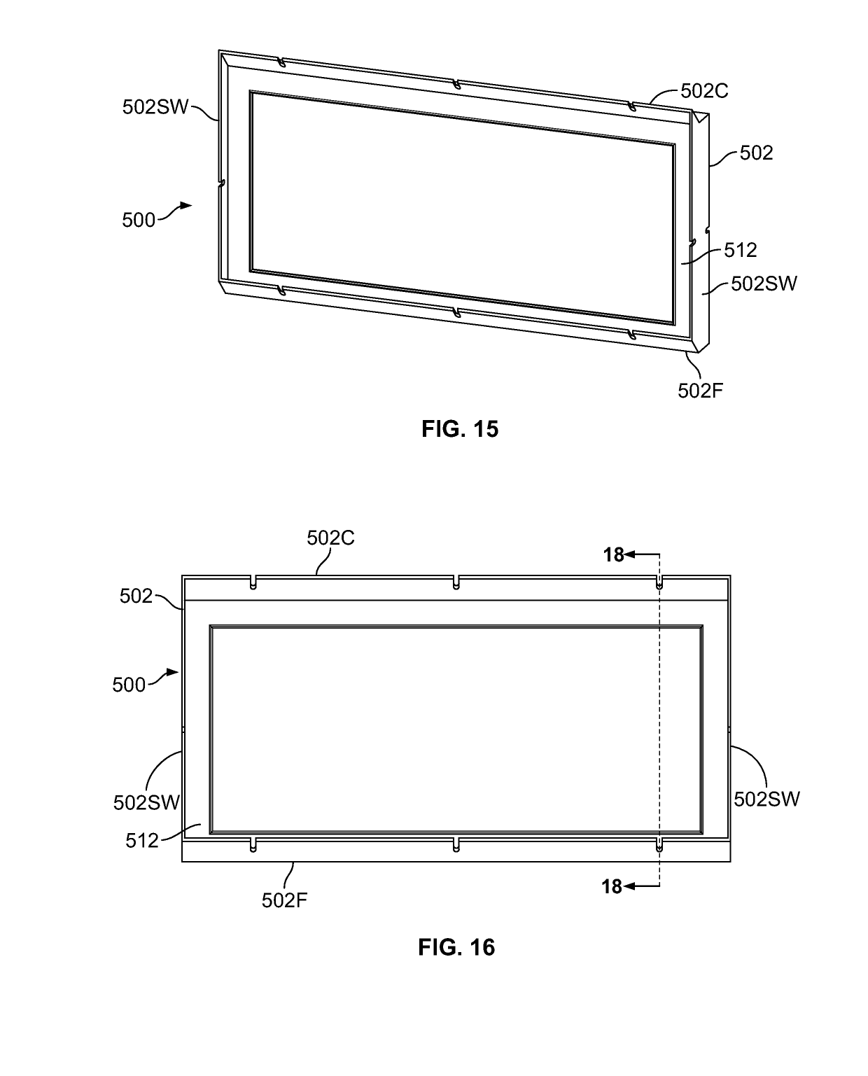

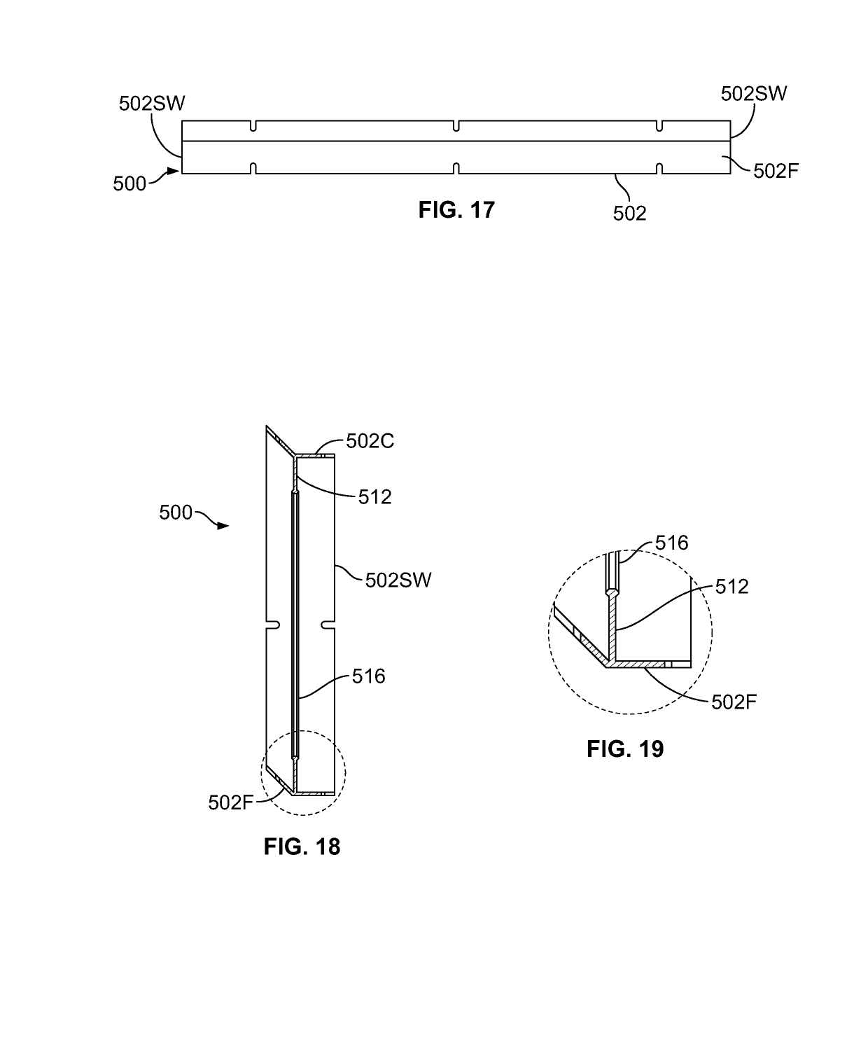

FIG. 15 shows a perspective view of a duct interconnect device according to the present disclosure. FIG. 16 shows a frontal view of a duct interconnect device according to the present disclosure. FIG. 17 shows a lateral side view of a duct interconnect device according to the present disclosure. FIG. 18 shows a cross-sectional lateral side view of a duct interconnect device according to the present disclosure. FIG. 19 shows a close-up of a cross-sectional lateral side view of a duct interconnect device according to the present disclosure. Some elements of these figures are described above. Thus, same reference characters identify identical and/or like components described above and any repetitive detailed description thereof will hereinafter be omitted or simplified in order to avoid complication.

A duct interconnect device 500 can be at least partially structurally similar to at least one of the duct interconnect device 100 or the duct interconnect device 400. The duct interconnect device 500 includes a tube 502 and a wall 512, as described above. The tube 502 includes a ceiling 502C, a floor 502F, and a pair of sidewalls 502SW spanning between the ceiling 502C and the floor 502F. The wall 512 includes a top side 516, as described above.

A difference between the duct interconnect device 100 and the duct interconnect device 500 is that the ceiling 502C and the floor 502F are chamfered vertically, one internally and one externally, whether identical to or different from each other in angling, size, shape, material, or structure, as described herein. The sidewalls 502SW are structured accordingly. Resultantly, the duct interconnect device 500 is able to interconnect a pair of ducts along a non-rectilinear fluid conduction path.

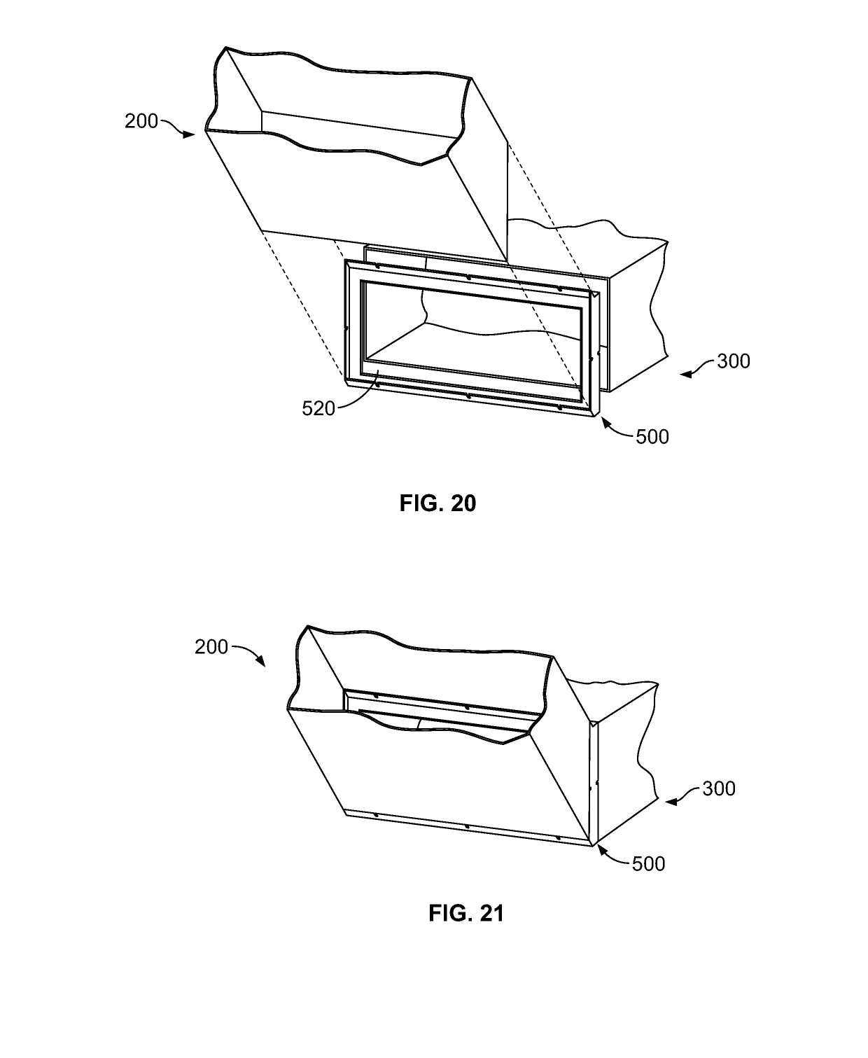

FIG. 20 shows a perspective view of a duct interconnect device before interconnecting a pair of ducts along a non-rectilinear conduction path according to the present disclosure. FIG. 21 shows a perspective view of a duct interconnect device after interconnecting a pair of ducts along a non-rectilinear conduction path according to the present disclosure. Some elements of these figures are described above. Thus, same reference characters identify identical and/or like components described above and any repetitive detailed description thereof will hereinafter be omitted or simplified in order to avoid complication.

The duct interconnect device 500 is sized to receive at least one of the duct 200 or the duct 300 in a nesting manner such that at least one of the duct 200 or the duct 300 is positioned along an inner side within the tube 502 of the duct interconnect device 500 and at least one of the duct 200 or the duct 300 is able to contact a lateral side of the wall 512. Such contact can enable securing, as described herein. However, note that at least one of the duct 200 or the duct 300 can be positioned along the inner side within the tube 502 of the duct interconnect device 500, yet not contact the lateral side of the wall 512 such that an open space is defined. Note that such positioning can also enable securing, as described herein.

The duct 200 is coupled to the duct 300 via the duct interconnect device 500 such that the duct 200 and the duct 300 fluidly communicate with each other via the duct interconnect device 500 through the opening 520. At least one of the duct 200 or the duct 300 can be as described herein, such as disclosed in U.S. Pat. No. 8,667,995 or U.S. Provisional Patent Application 62/134,516, both of which are fully incorporated by reference herein for all purposes. Note that the duct 200 and the duct 300 can be identical to or different from each other in size, shape, structure, material, weight, internal volume, or any other duct property or characteristic.

The duct interconnect device 500 can be secured to at least one of the duct 200 or the duct 300 via the fasteners 122 fastening through a set of U-shaped open slots into at least one of the duct 200 or the duct 300, whether solely, alternatively, or along with other ways of coupling, such as via fastening, adhering, mating, interlocking, clamping, hook-and-looping, magnetizing, or other coupling manners. Note that the duct interconnect device 500 can also secure to at least one of the duct 200 or the duct 300 via the fasteners 122 through a set of bores extending through the wall 512. Further, note that the duct interconnect device 500 can be flush with at least one of the duct 200 or the duct 300 such that an outer side of the duct interconnect device 500 is coplanar with an outer side of at least one of the duct 200 or the duct 300. In other embodiments, the duct interconnect device 500 can be non-flush, such as nested or telescoped, with at least one of the duct 200 or the duct 300 such that the outer side of the duct interconnect device 500 is non-coplanar with the outer side of at least one of the duct 200 or the duct 300. Resultantly, the duct interconnect device 500 enables a conduction of a fluid along a non-rectilinear path, such as a vertically arcuate path, between the duct 200 and the duct 300 through the opening 520 of the duct interconnect device 500.

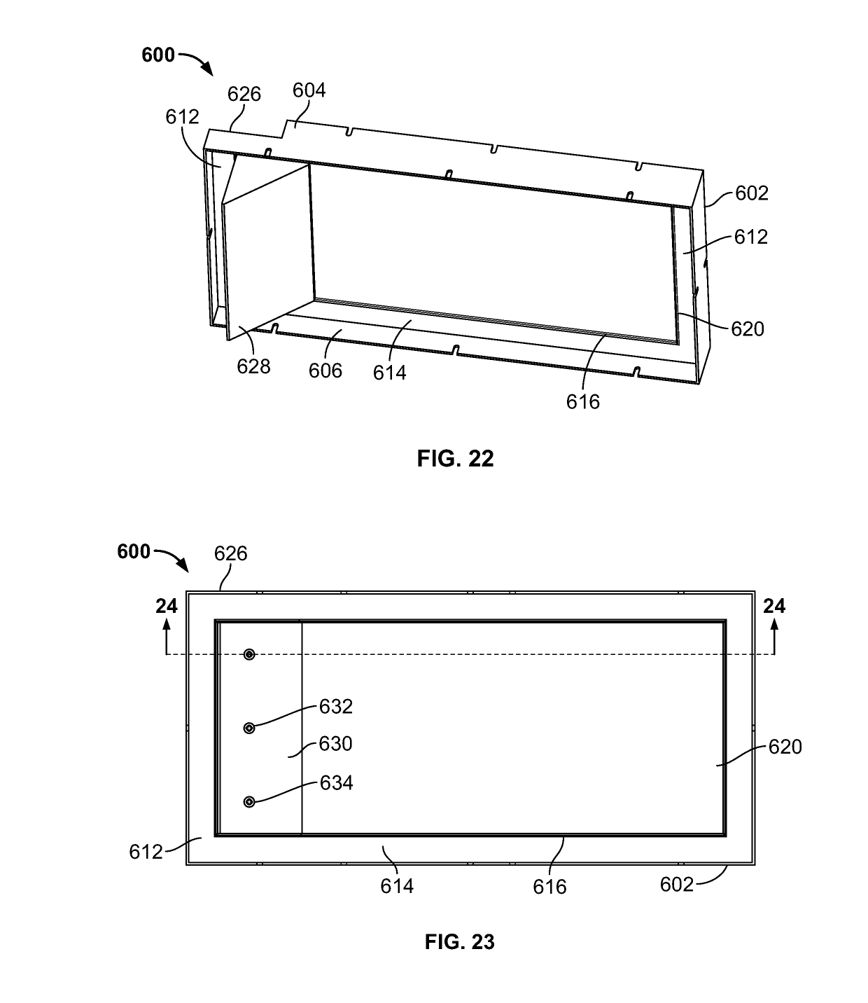

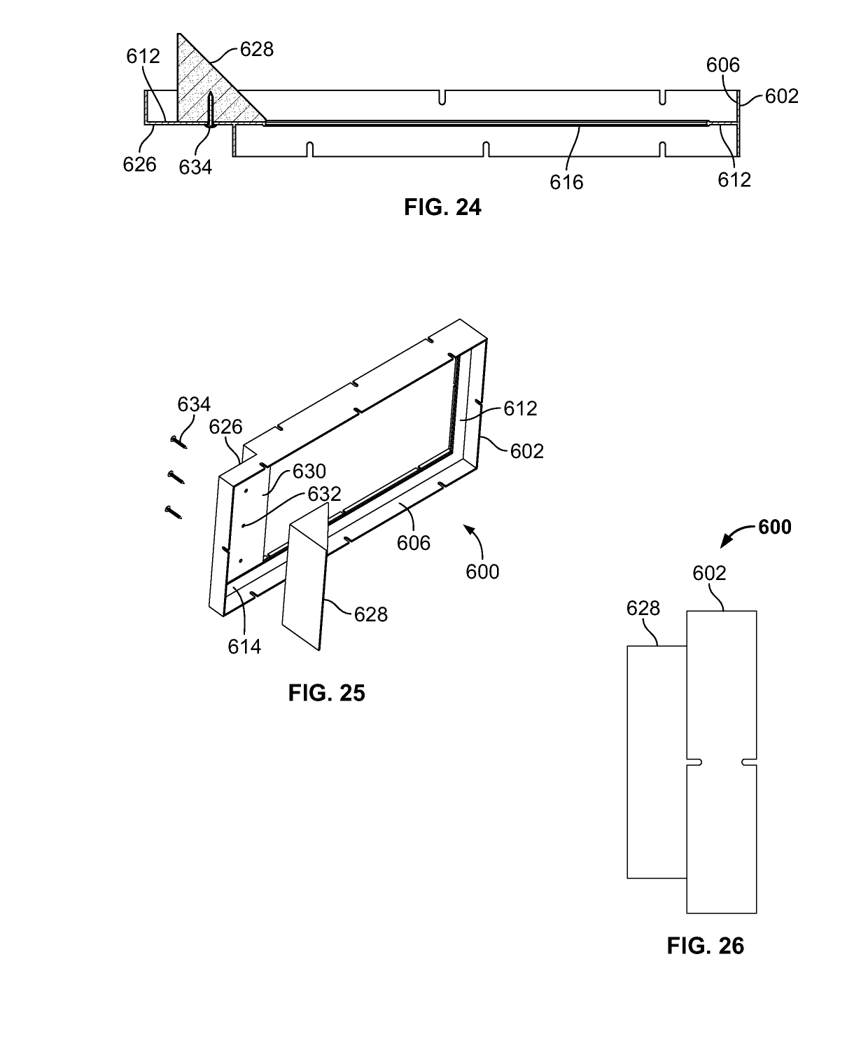

FIG. 22 shows a perspective view of a duct interconnect device with a wedge according to the present disclosure. FIG. 23 shows a frontal view of a duct interconnect device with a wedge according to the present disclosure. FIG. 24 shows a cross-sectional lateral side view of a duct interconnect device with a wedge according to the present disclosure. FIG. 25 shows a perspective view of a duct interconnect device with a wedge according to the present disclosure. FIG. 26 shows a lateral side view of a duct interconnect device with a wedge according to the present disclosure. Some elements of these figures are described above. Thus, same reference characters identify identical and/or like components described above and any repetitive detailed description thereof will hereinafter be omitted or simplified in order to avoid complication.

A duct interconnect device 600 can be at least partially structurally similar to at least one of the duct interconnect device 100, the duct interconnect device 400, or the duct interconnect device 500. The duct interconnect device 600 includes a tube 602 and a wall 612, as described above. The tube 602 includes an outer side 604 and an inner side 606. The wall 612 includes a lateral side 614 and a top side 616. The top side 616 defines an opening 620. The tube 602 includes an extended section 626, which is inwardly stepped. However, other structural configurations of such extensions are possible, such as non-stepped or outwardly stepped.

The device 600 includes a base plate 630. The base plate 630 spans across the opening 620 between the top sides 616 of the wall 612. In other embodiments, the base plate 630 spans diametrically across the tube 602 between the inner sides 606. In other embodiments, the base plate 630 is cantilevered from any part of at least one of the tube 602, such as the inner side 616, or the wall 612, such as the lateral side 614 or the top side 616, whether internal to at least one of the tube 602 or the wall 612 or whether external to at least one of the tube 602 or the wall 612.

The base plate 630 and the wall 612 are a single piece, such as unitary. However, in other embodiments, the base plate 630 and the wall 612 are an assembly of pieces. In other embodiments, the base plate 630 and the tube 602 are a single piece, such as unitary. However, in other embodiments, the tube 602 and the base plate 630 are an assembly of pieces.

The base plate 630 includes plastic, but can include metal, wood, glass, stone, rubber, or any other material, whether biodegradable, flame-retardant, bacteria-resistant, or leak-proof, whether internally or externally, whether alone or in combination with others. The base plate 630 can be seamed or seamless. The base plate 630 is rectangular in shape, but can be shaped differently, such as triangular, circular, oval, square, trapezoid, pentagon, hexagon, octagon, or any other geometric shape. The base plate 630 can have an R-value of thermal insulation identical to or different from at least one of the tube 602 or the wall 612.

The base plate 630 is relatively uniform in thickness. In other embodiments, the base plate 630 varies in thickness. Also, the base plate 630 can be sufficiently thick to be fully flush with the outer side 604 of the tube 602, such as via the extended section 626 not being stepped. The base plate 630 is solid, but can be perforated.

The base plate 630 defines a set of bores 632 extending therethrough. At least one of the bores 632 is circular.

The device 600 includes a wedge 628, which has a triangular cross-section, which enables expansion of fluid conductivity to a wider duct or contraction to a narrower duct. Note that such structure is one example of the wedge 628 and other wedge shapes can be used, such as a pyramid. The wedge 628 includes plastic, but can include metal, wood, glass, stone, rubber, foam, or any other material, whether biodegradable, flame-retardant, bacteria-resistant, or leak-proof, whether internally or externally, whether alone or in combination with others. The wedge 628 can be seamed or seamless. The wedge 628 is solid, but can perforated. The wedge 628 can have an R-value of thermal insulation identical to or different from at least one of the tube 602, the base plate 630, or the wall 612.

The wedge 628 is secured to the base plate 630 via a set of fasteners 634 extending through the base plate 630 into the wedge 628. For example, at least one of the fasteners 634 can be a bolt or a screw, which can be capable of coupling to a nut, such as helically. At least one of the fasteners 634 can include plastic, metal, wood, glass, stone, rubber, or any other material, whether biodegradable, flame-retardant, bacteria-resistant, or leak-proof. At least one of the fasteners 634 can be a one-piece construction or an assembly. In other embodiments, the wedge 628 is secured to the base plate 630 in other manners, whether solely, alternatively, or along with other ways of coupling, such as via fastening, adhering, mating, interlocking, clamping, hook-and-looping, magnetizing, or other coupling manners. For example, the wedge 628 can be adhered to the base plate 630, such as via a glue, so that the bores 632 can be omitted, but the bores 632 can also be present, such as for ventilation. In yet other embodiments, the wedge 628 and the base plate 630 are one-piece. In still other embodiments, the wedge 628 and the wall 612 are one-piece, such as spanning across the opening 620, whether across the lateral sides 114 or the top sides 116. In still other embodiments, the wedge 628 and the wall 612 are an assembly of pieces, such as spanning across the opening 620, whether across the lateral sides 114 or the top sides 116. In still other embodiments, the wedge 628 and the tube 602 are one-piece, such as spanning between the inner sides 606. In still other embodiments, the wedge 628 and the tube 602 are an assembly of pieces, such as panning between the inner sides 606. In still other embodiments, the wedge 628 is cantilevered from at least one of the lateral side 614 or the top side 616. In still other embodiments, the wedge 628 is cantilevered from the inner side 606.

In some embodiments, the base plate 630 can include a computer or a sensor, such as a thermometer, a fluid pressure sensor, or another material property sensor, which can be configured for communication, whether in a wired or a wireless manner with another device, such as a mobile device, for instance, a tablet computer. In some embodiments, an outer side of the tube 602 comprises a photovoltaic cell configured to receive light energy and create electrical energy for storage within a power storage device, such as a battery. Note that power storage device can be configured to provide power to the computer or the sensor. Also, note that the tube 602 can be positioned within a duct, a device, an apparatus, a machine, or a freestanding structure. In some embodiments, the tube 602 can include a network communication station, such as an antenna-based cell site or a network router, which can be powered via mains electricity, a power storage device, such as a battery, or the photovoltaic cell, whether local to the duct interconnect device 600 or remote to the duct interconnect device 600. For example, the network router can be a local area network (LAN) router.

In some embodiments, the wedge 628 can include a computer or a sensor, such as a thermometer, a fluid pressure sensor, or another material property sensor, which can be configured for communication, whether in a wired or a wireless manner with another device, such as a mobile device, for instance, a tablet computer. In some embodiments, an outer side of the tube 602 comprises a photovoltaic cell configured to receive light energy and create electrical energy for storage within a power storage device, such as a battery. Note that the power storage device can be configured to provide power to the computer or the sensor. Also, note that the duct interconnect device 600 can be chamfered for lateral or vertical fluid conduction, as described herein.

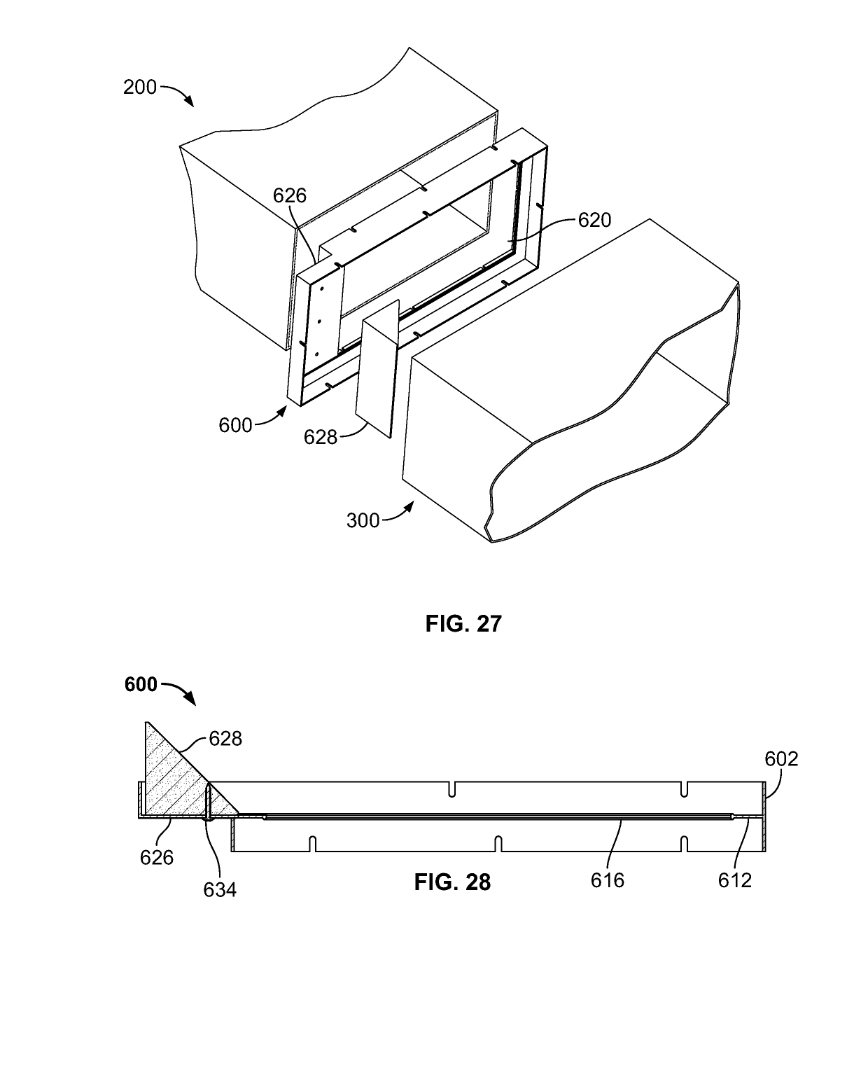

FIG. 27 shows a perspective view of a duct interconnect device with a wedge before interconnecting a pair of ducts along a rectilinear conduction path according to the present disclosure. Some elements of this figure are described above. Thus, same reference characters identify identical and/or like components described above and any repetitive detailed description thereof will hereinafter be omitted or simplified in order to avoid complication.

The duct 200 is narrower than the duct 300, such as in at least one of a width or a height. Accordingly, the duct interconnect device 600 is used to interconnect the duct 200 and the duct 300 such that the duct 200 and the duct 300 are in fluid communication with each other via the opening 620 of the duct interconnect device 600. Note that the extended section 626 enables a receipt of the duct 300, which is wider than the duct 200. Likewise, a presence of the wedge 628 allows for a change in at least one of a direction, a pressure, or a volume of a fluid, whether in expansion or contraction. Further, note that the extended section 626 extends out laterally past the duct 200. Also, note that although the duct interconnect device 600 allows for the change in at least one of the direction, the pressure, or the volume of the fluid rectilinearly along a horizontal axis, in other embodiments, the duct interconnect device 600 can allow for the change in at least one of the direction, the pressure, or the volume of the fluid rectilinearly or non-rectilinearly, such as arcuate, sinusoidal, pulsating, or zigzag, along a horizontal axis, a vertical axis, or a diagonal axis, as described herein, such as via chamfering, as described herein.

FIG. 28 shows a cross-sectional lateral side view of a duct interconnect device with a wedge according to the present disclosure. Some elements of this figure are described above. Thus, same reference characters identify identical and/or like components described above and any repetitive detailed description thereof will hereinafter be omitted or simplified in order to avoid complication.

A difference between FIG. 24 and FIG. 28 is how far the wedge 628 is positioned from the inner side 606 of the tube 602. In FIG. 24, the wedge 628 is spaced apart from the inner side 606 such that a first open space is defined and the wedge 628 avoids contacting the inner side 606. In FIG. 28, the wedge 628 is spaced apart from the inner side 606 such that a second open space is defined and the wedge 628 avoids contacting the inner side 606, wherein the first open space is greater in length than the second open space. In other embodiments, the wedge 628 contacts the inner side 606. In yet other embodiments, the duct interconnect device 600 contains an object within at least one of the first open space or the second open space. For example, the object can comprise a block, a computer, a bracket, or a sensor.

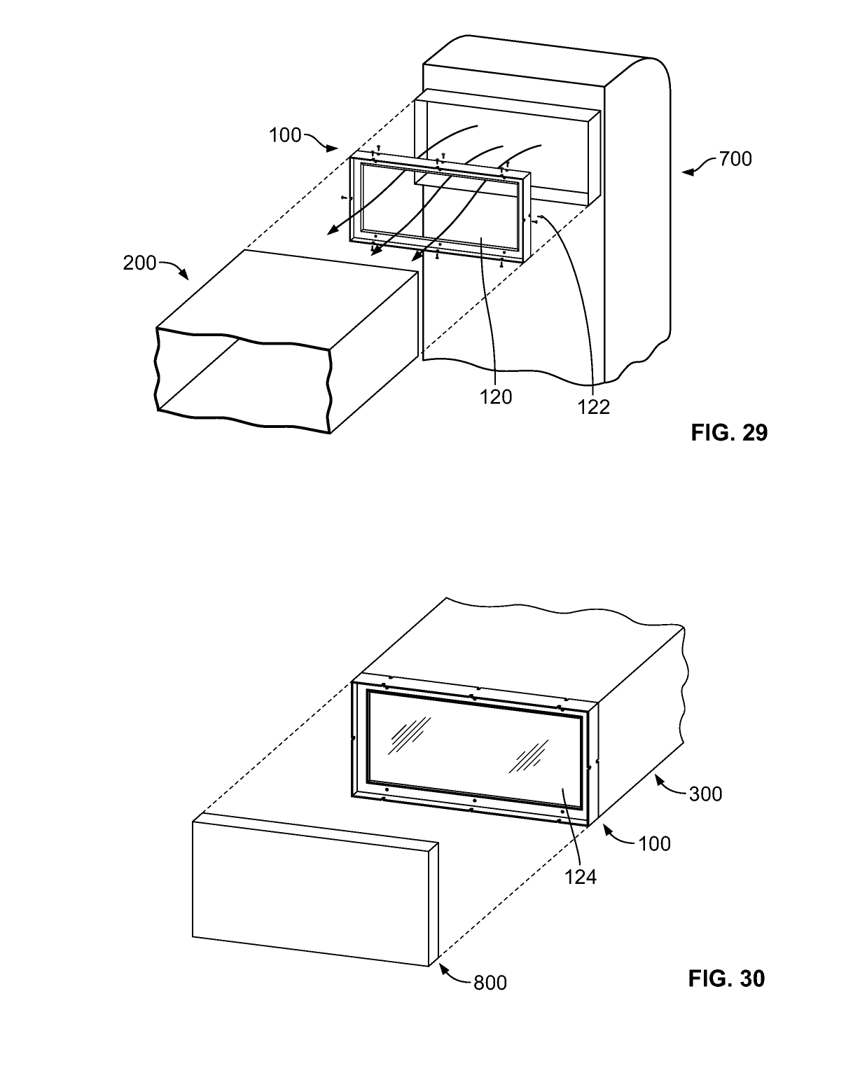

FIG. 29 shows a perspective view of a duct interconnect device before interconnecting a pair of ducts along a rectilinear conduction path according to the present disclosure. Some elements of this figure are described above. Thus, same reference characters identify identical and/or like components described above and any repetitive detailed description thereof will hereinafter be omitted or simplified in order to avoid complication.

The duct interconnect device 100 is sized to receive at least one of the duct 200 or a fluid source 700 in a nesting manner such that at least one of the duct 200 or the fluid source 700 is positioned along the inner side 106 within the tube 102 of the duct interconnect device 100 and at least one of the duct 200 or the fluid source 700 is able to contact the lateral side 114 of the wall 112. Such contact can enable securing, as described herein. However, note that at least one of the duct 200 or the fluid source 700 can be positioned along the inner side 106 within the tube 102 of the duct interconnect device 100, yet not contact the lateral side 114 of the wall 112 such that an open space is defined. Note that such positioning can also enable securing, as described herein.

The duct 200 is coupled to the fluid source 700 via the duct interconnect device 100 such that the duct 200 and the fluid source 700 fluidly communicate with each other via the duct interconnect device 100 through the opening 120. At least one of the duct 200 or the fluid source 700 can be as described herein, such as disclosed in U.S. Pat. No. 8,667,995 or U.S. Provisional Patent Application 62/134,516, both of which are fully incorporated by reference herein for all purposes. Note that the duct 200 and fluid source 700 can be identical to or different from each other in size, shape, structure, material, weight, internal volume, or any other duct property or characteristic.

The duct interconnect device 100 is secured to at least one of the duct 200 or the fluid source 700 via the fasteners 122 fastening through the open slots 110 into at least one of the duct 200 or the fluid source 700, whether solely, alternatively, or along with other ways of coupling, such as via fastening, adhering, mating, interlocking, clamping, hook-and-looping, magnetizing, or other coupling manners. Note that the duct interconnect device 100 can also secure to at least one of the duct 200 or the fluid source 700 via fasteners 122 through the bores 118. Further, note that the duct interconnect device 100 can be flush with at least one of the duct 200 or the fluid source 700 such that the outer side 104 of the duct interconnect device 100 is coplanar with an outer side of at least one of the duct 200 or the fluid source 700. In other embodiments, the duct interconnect device 100 can be non-flush, such as nested or telescoped, with at least one of the duct 200 or the fluid source 700 such that the outer side 104 of the duct interconnect device 100 is non-coplanar with the outer side of at least one of the duct 200 or the fluid source 700. Resultantly, the duct interconnect device 100 enables a conduction of a fluid along a rectilinear path between the duct 200 and the fluid source 700 through the opening 120 of the duct interconnect device 100. In other embodiments, the duct interconnect device 100 enables a conduction of a fluid along a non-rectilinear path between the duct 200 and the fluid source 700 through the opening 120 of the duct interconnect device 100.

FIG. 30 shows a perspective view of a duct interconnect device being coupled to a duct and being closed off according to the present disclosure. Some elements of this figure are described above. Thus, same reference characters identify identical and/or like components described above and any repetitive detailed description thereof will hereinafter be omitted or simplified in order to avoid complication.

A block 800 is configured to be positioned within the tube 102 such that the block 800 extends between the inner sides 106 of the tube 100 and that the wall 112 is positioned between the block 800 and the plate 124. For example, the block 800 can span between the inner sides 106. Also, for example, the block 800 can rest within the tube 102 snugly. Further, for example, the block 800 can be flush with one of the end portions 105, 107 of the tube 102 or extend past one of the end portions 105, 107. Moreover, for example, an open space can be defined between the block 800 and the plate 124. However, at least one of the block 800 or the plate 124 can be configured to contact each other as well. In yet other embodiments, the block 800 and the plate 124 are one-piece.

The block 800 closes up the opening 120 from a side different from the plate 124. Such closing can be hermetic sealing, such as airtight, whether directly or indirectly, such as with an adhesive sealant closing up a seam between the inner side 106 of the tube 102 and the block 800. The block 800 can be coupled to the top side 116 or the lateral side 114 of the wall 112. The block 800 can coupled to the inner side 106 of the tube 102. Such coupling can be via fastening, adhering, mating, interlocking, clamping, hook-and-looping, magnetizing, or other coupling manners. The block 800 can be opaque, transparent, or translucent. The block 800 can be reflective or anti-reflective. The block 800 can include plastic, metal, wood, glass, stone, rubber, or any other material, whether biodegradable, flame-retardant, bacteria-resistant, or leak-proof.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be fully exhaustive and/or limited to the disclosure in the form disclosed. Many modifications and variations in techniques and structures will be apparent to those of ordinary skill in the art without departing from the scope and spirit of the disclosure as set forth in the claims that follow. Accordingly, such modifications and variations are contemplated as being a part of the present disclosure. The scope of the present disclosure is defined by the claims, which includes known equivalents and unforeseeable equivalents at the time of filing of the present disclosure.

1. A method of climate control, the method comprising:
accessing a duct comprising a tube and a wall, wherein the tube comprises an inner side, wherein the tube comprises a first open end portion and a second open end portion, wherein the wall includes a top side, wherein the wall extends from the inner side such that the top side is distal to the inner side and such that the top side extends in a closed-shape along a lateral cross section of the duct, wherein the wall is recessed with respect to the first open end portion and the second open end portion;
conducting an air through the tube such that the air travels past the top side through the closed-shape.

2. The method of claim 1, wherein the tube comprises an outer side, wherein the tube defines an open-shaped slot via the outer side and the inner side.

3. The method of claim 1, wherein the wall defines a bore extending therethrough along the top side.

4. The method of claim 1, wherein the tube comprises a first sidewall and a second sidewall, wherein the first sidewall opposes the second sidewall, wherein the first sidewall is laterally chamfered internally and the second sidewall is laterally chamfered externally such that the air is conducted along a non-rectilinear conduction path along a horizontal plane.

5. The method of claim 1, wherein the tube comprises a first sidewall and a second sidewall, wherein the first sidewall opposes the second sidewall, wherein the first sidewall is vertically chamfered internally and the second sidewall is vertically chamfered externally such that the air is conducted along a non-rectilinear conduction path along a vertical plane.

6. The method of claim 1, wherein the duct is a first duct, and further comprising:
positioning a wedge into the tube along the top side such that the wedge guides the air into a second duct, wherein the first duct and the second duct are different in width.

7. The method of claim 6, wherein the wedge comprises at least one of a computer or a sensor.

8. The method of claim 6, wherein the first duct comprises a plate contacting the wall, wherein the wedge is secured to the plate.

9. The method of claim 8, wherein at least one of the plate or the wedge comprises a computer or a sensor.

10. The method of claim 8, wherein the wedge is secured to the plate via a fastener.

11. The method of claim 6, wherein the wedge contacts the inner side.

12. The method of claim 6, wherein the wedge avoids contact with the inner side.

13. The method of claim 6, wherein the wedge is a right triangle wedge.

14. The method of claim 6, wherein the wedge comprises an R-value no less than the wall.

15. The method of claim 1, further comprising:
positioning a block into the duct adjacent to the wall such that the block engages the air.

16. A method of fluid conduction, the method comprising:
accessing a duct comprising a tube and a wall, wherein the tube comprises an inner side, wherein the tube comprises a first open end portion and a second open end portion, wherein the wall includes a top side, wherein the wall extends from the inner side such that the top side is distal to the inner side and such that the top side extends in a closed-shape along a lateral cross section of the duct, wherein the wall is recessed with respect to the first open end portion and the second open end portion;
conducting a fluid through the tube such that the fluid travels past the top side through the closed-shape.

17. The method of claim 16, wherein the tube comprises an outer side, wherein the tube defines an open-shaped slot via the outer side and the inner side.

18. The method of claim 16, wherein the wall defines a bore extending therethrough along the top side.

19. The method of claim 16, wherein the tube comprises a first sidewall and a second sidewall, wherein the first sidewall opposes the second sidewall, wherein the first sidewall is chamfered internally and the second sidewall is chamfered externally such that the fluid is conducted along a non-rectilinear conduction path.

20. The method of claim 16, wherein the duct is a first duct, and further comprising:
positioning a wedge into the tube along the top side such that the wedge guides the air into a second duct, wherein the first duct and the second duct are different in width.

21. The method of claim 21, wherein the first duct comprises a plate contacting the wall, wherein the wedge is secured to the plate.
